(19) United States
(12) Patent Application Publication
(10) Pub. No.: US 2007/0091594 A1
(43) Pub. Date: Apr. 26, 2007

(54) Solar Powered Portable Light Apparatus

(76) Inventor: Wai Kiat Michael Soon, Calgary (CA)

Correspondence Address: KEN BURRASTON;KIRTON & MCCONKIE, PO BOX 45120, SALT LAKE CITY, UT, 84145-0120, US

(21) Appl. No.: 11/163,498

(22) Filed: Oct. 20, 2005

(51) Int. Cl. F21L 4/00

(52) U.S. Cl. 362/183

(57) ABSTRACT

A light apparatus includes a light source and a solar power source configured to provide solar generated power for powering the light source. The solar generated power may charge a battery, which provides power to the light source. The light source and the solar power source may be disposed in a single product that is portable, and the light apparatus may be a camp lantern.

### BACKGROUND

Solar power is emerging as an inexpensive, convenient, renewable, and environmentally friendly source of electrical power. Solar energy cells convert light (e.g., from the sun) into electrical energy. Known solar energy cells include, without limitation, cells comprising doped semiconductor materials. Exemplary embodiments of the present invention utilize solar power to power a portable light apparatus.

### SUMMARY

An exemplary embodiment of the present invention comprises a light apparatus having a light source, and a solar power source configured to provide solar generated power for powering the light source. The solar generated power may charge a battery, which provides power to the light source. The light source and the solar power source may be disposed in a single product that is portable. In one embodiment, the light apparatus is a camp lantern.

### DESCRIPTION OF THE DRAWINGS

FIG. 1 shows a side view of an exemplary portable light apparatus according to some embodiments of the invention.

FIG. 2 shows a top view of the portable light apparatus of FIG. 1.

FIG. 3 shows a side, cross-sectional view of the portable light apparatus of FIG. 1.

FIG. 4 shows an exemplary electronic circuit that may be used with the portable light apparatus of FIG. 1.

### DETAILED DESCRIPTION OF EXEMPLARY EMBODIMENTS

This specification describes exemplary embodiments and applications of the invention. The invention, however, is not limited to these exemplary embodiments and applications or to the manner in which the exemplary embodiments and applications operate or are described herein.

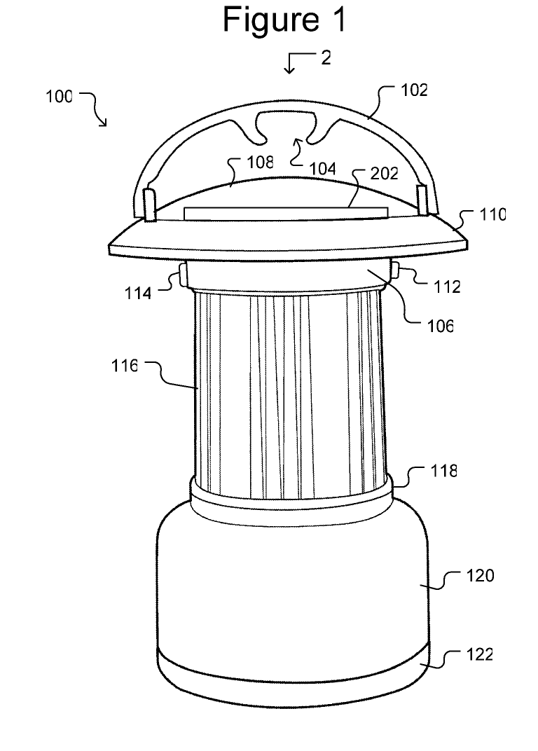

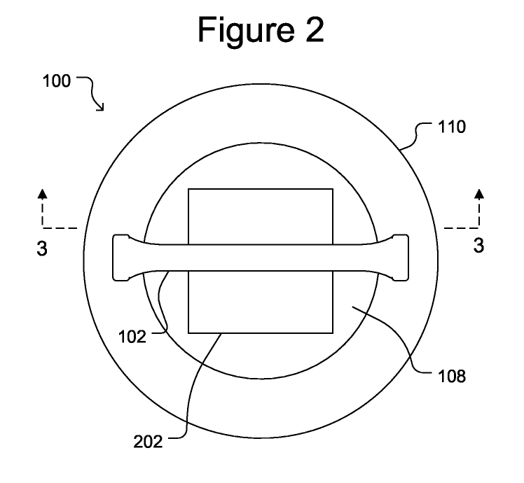

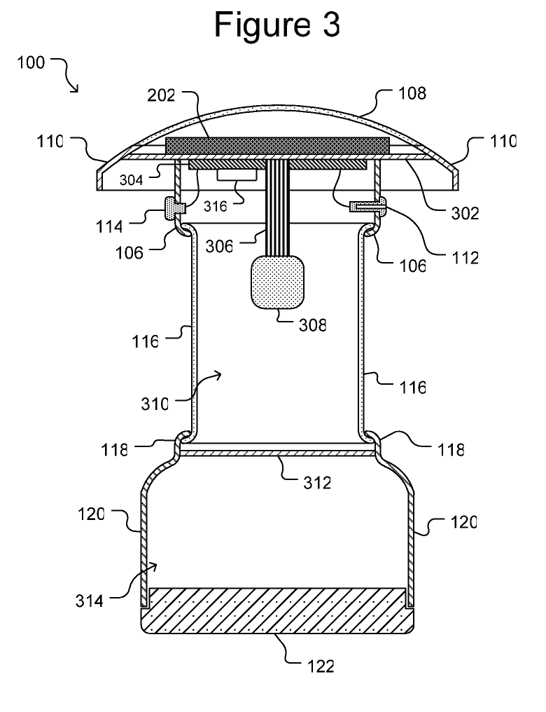

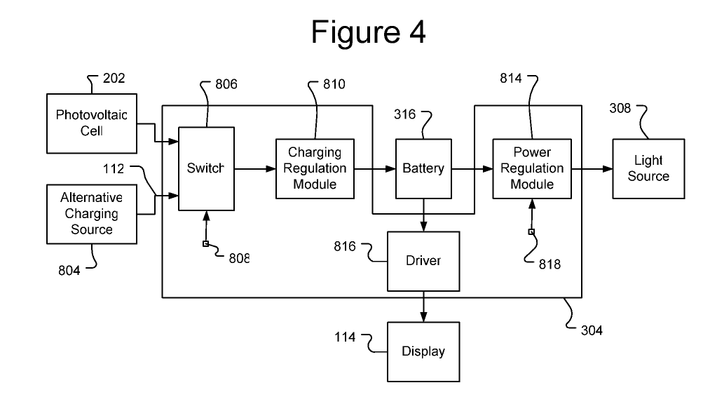

FIGS. 1-4 illustrate an exemplary portable light apparatus 100 according to some embodiments of the invention. As will be seen, portable light apparatus 100 is battery powered and includes both a solar cell for charging the battery or batteries utilizing solar power and a power input jack for charging the batteries using an external source of alternating current or direct current power. FIG. 1 shows a side view, FIG. 2 shows a top view, and FIG. 3 shows a side, cross-sectional view of portable light apparatus 100. FIG. 4 illustrates exemplary electronic circuitry for the portable light apparatus 100.

Referring to FIGS. 1-3, portable light source 100 includes a handle 102, which allows a user to carry the light source 100 from place to place. The handle 102 includes a clip 104, which facilitates hanging the light source 100 from a support structure (not shown).

A light collection window 108 and rim structure 110 form an upper portion of light source 100. An upper attachment structure 106 extends downward from an inner flooring 302 (visible only in FIG. 3) of rim structure 110 and attaches to the top of a cylindrical window 116. A base cap 122 threads into the bottom of a base 120, and a bottom attachment structure 118 extends from the top of the base 120 and attaches to the bottom of the cylindrical window 116.

A photovoltaic cell 202 is disposed on inner flooring 302 (visible in FIG. 3 only). Light collection window 108 allows light (e.g., from the sun) to pass through and strike photovoltaic cell 202, causing photovoltaic cell 202 to generate a current and/or voltage. Many such photovoltaic cells are known, including without limitation cells comprising doped semiconductor materials, and any such photovoltaic cell may be used. The current and/or voltage generated by photovoltaic cell 202 is output to circuitry 304 (visible only in FIG. 3), which may be a printed circuit board with electrically interconnected circuit components (e.g., integrated circuit “chips,” resistors, capacitors, etc.). Circuitry 304 also provides an electrical connection to a display device 114 and a power input jack 112. As shown in FIG. 3, circuitry 304 is attached to flooring 302.

A light source support 306 is also attached to flooring 302 and extends into a light cavity 310 inside cylindrical window 116 as shown in FIG. 3. A light source 308 (e.g., a light bulb) can be attached to and detached from light source support 306, and light source support 306 provides a power connection from batteries 316 to light source 308.

Base 120 is hollow, and a base cap 122 threads into the bottom of base 120. As shown in FIG. 3, the side walls, a ceiling structure 312, and base 120 define a storage compartment 314, which may be used to store such things as a power adapter (not shown) for supplying alternating current or direct current power through jack 112.

Light collection window 108 and cylindrical window 116 may be made of any material that is transparent or semi-transparent to light. Non-limiting examples of such materials include clear plastics and glass. Rim structure 110, flooring structure 302, and upper attachment structure 106 may be made of any suitable material, include sturdy and rigid materials. Non-limiting examples of such materials include hard plastics, steel or other metals, etc. Moreover, rim structure 110, flooring structure 302, and upper attachment structure 106 may be integrally formed as one structure or may be separate structures that are attached one to another.

Base 120, lower attachment structure 118, and ceiling structure 312 may likewise be made of any suitable material, including sturdy and rigid materials, non-limiting examples of which include hard plastics, steel or other metals, etc. And base 120, lower attachment structure 118, and ceiling structure 312 may be integrally formed as one structure or may be separate structures that are attached one to another.

Light collection window 108 may be attached to rim structure 110 in any suitable manner. For example, light collection window 108 may snap fit into rim structure 110. As another example, light collection window 108 may be screwed, bolted, clamped, glued, etc. to rim structure 110. Cylindrical window 116 may likewise be attached to upper attachment structure 106 and lower attachment structure 118 in any suitable manner, including without limitation using snap fits, screws, bolts, clamps, glue, etc. Light source support 306 may likewise be attached to flooring structure 302 using snap fits, screws, bolts, clamps, glue, etc.

Light apparatus 100 may be constructed to be water proof and/or resistant to other weather elements, such as wind, etc. For example, all of the elements of light apparatus 100 that form an outer surface of light apparatus may be formed of water and/or weather proof materials. In addition, the joints between such elements may be provided with water proof and/or weather proof gaskets, seals, or other means of protecting inner portions of light apparatus 100 from water and/or other damaging weather elements. Thus, for example, light collection window 108, rim structure 110, upper attachment structure 106, cylindrical window 116, lower attachment structure 118, base 120, and base cap 122 may be constructed of water and/or weather proof materials, and the joints between each of those elements may be fitted with water and/or weather proof gaskets or seals.

FIG. 4 illustrates an exemplary implementation of circuit 304 according to some embodiments of the invention. As shown, the exemplary implementation of circuit 304 shown in FIG. 4 includes a switch 806, charging regulation module 810, driver 816, and power regulation module 814.

Battery 316 (which may comprise more than one battery) provides power for light source 308, and power regulation module 814 regulates the supply of power from battery 316 to light source 308, which may be a light emitting diode, conventional light bulb, or any other electrically driven light source. Among other functions, power regulation module 814 may monitor the charge stored in battery 316 and cut power from battery 316 to light source 308 if the charge stored in battery 316 drops below a predetermined level. As is known, the operating life of many types of rechargeable batteries may be shortened if the charge stored in the batteries is fully dissipated. In addition, if the charge stored in battery 316 drops below a predetermined level, the remaining charge may be reserved solely to power circuit 304.

Power regulation module 814 may receive an input 818 that causes power to be cut to light source 308 regardless of the level of the charge stored in battery 316. For example, input 818 may originate from an on/off switch (not shown) on light apparatus 100 that allows a user to turn light source 308 on and off.

As shown, driver 816 may receive a signal from battery 316 indicative of the level of charge stored in battery 316, and driver 816 may utilize the signal from battery 316 to drive display 144 to display information regarding the level of charge stored in battery 316. For example, display 114 may display an indication showing the level of charge stored in battery 316. As another example, display 114 may display a warning that the charge stored in battery 316 has dropped below a predetermined level.

As shown in FIG. 4, battery 316 may be charged by photovoltaic cell 202, which as discussed above, produces a current and/or voltage when struck by light (e.g., from the sun). Circuit 304 includes a switch 806 for selecting between photovoltaic cell 202 and an alternative charging source 804 (which may represent one or more alternative charging sources). For example, alternative charging source 804 may be alternating current power available through standard electrical outlets in homes and commercial buildings. Such a power source may be connected to light apparatus 100 through jack 112. Input 808 to switch controls which source of power—from photovoltaic cell 202 or alternative charging source 804—is provided through switch 806 to charging regulation module 810 and then to battery 316. Input 808 may originate from a user activated switch on light apparatus 100.

Alternatively, input 808 may be dependent on the presence or absence of an input plug (not shown) in jack 112. In such a configuration, if a plug is present in jack 112, input 808 causes switch to select the output of alternative charging source 804 as the power passed to charging regulation module 810. On the other hand, if a plug is not present in jack 112, input 808 causes switch 806 to select the output of photovoltaic cell 202 as the power presented to charging regulation module 810.

Power from photovoltaic cell 202 or alternative charging source 804, provided through switch 806 and charging regulation module 810, recharges battery 316. Charging regulation module 810 may comprise circuitry, such as one or more diodes, that allows current to flow from switch 806 to battery 316 but prevents current from flowing in the reverse direction, that is, from battery 316 to switch 806. Charging regulation module 810 may also include charge controlling circuitry configured to disconnect battery 316 from switch 806 while battery 316 is fully charged, which prevents battery 316 from over charging and may prolong the working life of battery 316. Thus, charging regulation module 810 may be configured to determine whether battery 316 is fully charged and connect power from photovoltaic cell 202 or alternative charging source 804 to battery 316 only while battery 316 is not fully charged.

Battery 316 may comprise one or more batteries of any type that is rechargeable. For example, battery 316 may comprise one or more deep cycle batteries (which are batteries that discharge a small current over a long period of time as opposed to a shallow cycle battery, which is configured to discharge large currents over a short period of time). Non-limiting examples of suitable batteries include nickel cadmium batteries or lead-acid batteries.

Because light apparatus 100 is portable and is capable of running solely from solar generated power (power generated by photovoltaic cell 202), light apparatus 100 has a number of uses and applications. For example, light apparatus 100 may be configured as a portable lantern for out door activities, such as camping. As another example, light apparatus 100 may be configured as a portable emergency light source. As yet another example, light apparatus 100 may be used as perhaps the only source of electrical light in rural areas where electrical power is not readily available. For example, in such an area, light apparatus 100 may be placed in direct sun light during day light hours to charge battery 316. Then, at night, relying solely on charged battery 316, light apparatus 100 provides light. Indeed, light apparatus 100 may be hung by clip 104 of handle 102 at night in homes that lack electrical power.

Although specific embodiments and applications of the invention have been described in this specification, there is no intention that the invention be limited these exemplary embodiments and applications or to the manner in which the exemplary embodiments and applications operate or are described herein.

What is claimed is:

1. A light apparatus comprising:
a light source; and
a solar power source configured to provide solar generated power for powering said light source,
wherein said light source and said solar power source are disposed in a single, portable product.

2. The light apparatus of claim 1, wherein said light source comprises a light emitting diode.

3. The light apparatus of claim 1 further comprising a battery, wherein:
said battery provides power to light said light source, and
said solar power source is configured to provide power to charge said battery.

4. The light apparatus of claim 3 further comprising power source means for providing an alternative source of power to charge said battery.

5. The light apparatus of claim 4 further comprising a switch for selecting one of said solar power source and said power source means to charge said battery.

6. The light apparatus of claim 3 further comprising means for regulating delivery of power to charge said battery.

7. The light apparatus of claim 3 further comprising means for disconnecting said battery from providing power to said light source if a level of charge stored in said battery falls below a predetermined level.

8. The light apparatus of claim 3 further comprising a display for displaying information relating to a level of charge stored in said battery.

9. The light apparatus of claim 1, wherein said single, portable product is a camp lantern.

10. A camp lantern comprising:
a housing;
a light source disposed within said housing;
a battery disposed within said housing and connected to said light source to provide power to said light source; and
a solar power source disposed within said housing and permanently attached to said housing and configured to provide power for charging said battery.

11. The camp lantern of claim 10, wherein said light source comprises a light emitting diode.

12. The camp lantern of claim 11 further comprising power source means for providing an alternative source of power to charge said battery.

13. The camp lantern of claim 12 further comprising a switch for selecting one of said solar power source and said power source means to charge said battery.

14. The camp lantern of claim 13 further comprising means for regulating delivery of power to charge said battery.

15. The camp lantern of claim 13 further comprising means for disconnecting said battery from providing power to said light source if a level of charge stored in said battery falls below a predetermined level.

16. The camp lantern of claim 15 further comprising a display for displaying information relating to a level of charge stored in said battery.

17. The camp lantern of claim 16, wherein said housing is weather proof.

18. The camp lantern of claim 17, wherein said housing is water proof.

19. The camp lantern of claim 18, wherein said camp lantern is portable.
